(19) United States
(12) Patent Application Publication
(10) Pub. No.: US 2007/0058378 A1
(43) Pub. Date: Mar. 15, 2007

(54) Socket device

(76) Inventors: Hideo Moriyama, Tokyo (JP); Kiyotoshi Hoshikawa, Tokyo (JP)

Correspondence Address: MARSHALL & MELHORN, FOUR SEAGATE, EIGHT FLOOR, TOLEDO, OH, 43604, US

(21) Appl. No.: 10/573,779

(22) PCT Filed: Mar. 11, 2005
(86) PCT No.: PCT/JP05/04296

§ 371 Date: Mar. 28, 2006

(30) Foreign Application Priority Data
Mar. 11, 2004 (JP) 2004-068827

(51) Int. Cl. F21V 15/00

(52) U.S. Cl. 362/378

(57) ABSTRACT

There is provided a socket device (1, 1a-1g), comprising a plurality of conductors (2); a socket main body (4) coupled to the conductors to hold them together and defining a cavity (5) having an opening at least in one surface to expose part of the conductors so that an electric element (3, 13, 22, 40) can be connected to the conductors exposed in the cavity; and a cap (6, 6a-6n, 6p) having a cap main body (7) for covering at least part of the one surface of the socket main body and attached to the socket main body.

### TECHNICAL FIELD

The present invention relates to a socket device that is attached to conductors for mounting a light emitting diode (LED) or the like.

### BACKGROUND ART

It has been proposed to manufacture a light emitting device comprising a plurality of LEDs by attaching the LEDs to a patterned conductor formed with a circuit by, e.g., patterning (or press working) a plate-shaped conductor, instead of using a printed circuit board (see Patent Document 1, for instance). In this document, it is disclosed to use electrically insulating sockets formed by molding, etc. so as to be integrally coupled to the conductors for the purpose of holding or positioning the LEDs. The socket defines a cavity with an opening on its top to expose the conductors to which the LED is to be attached, and the LED is held in the cavity. In order to achieve reliable electric connection of the LED and prevent faulty connection, it is proposed in the above document to make a cut in part of the conductor to form a tongue piece, and then bend the tongue piece to stand upright and press the LED received in the socket from above.

Patent Document 1: WO02/089222 (FIG. 22)

### DISCLOSURE OF THE INVENTION

### Objects to be Achieved by the Invention

However, the forming and bending of such a tongue piece in the conductor can make the manufacturing process complicated and thus lead to increase in the manufacturing cost of the light emitting device.

Also, it is desired in the light emitting device to achieve varieties of illumination effects by processing/controlling the light emitted from the LED in various fashions.

The present invention is made to solve such problems of the prior art, and a first object of the present invention is to achieve reliable connection between conductors and an electric element such as an LED received in a socket coupled to the conductors, without complicating the manufacturing process.

A second object of the present invention is to allow varieties of illumination effects to be achieved easily in a socket device (or light emitting device) comprising a light emitting element such as an LED received in a socket coupled to conductors.

A third object of the present invention is to allow various functions to be achieved easily by using the socket coupled to the conductors.

### Means to Achieve the Objects

In order to achieve the above objects, the present invention provides a socket device (1, 1a-1g), comprising a plurality of conductors (2); a socket main body (4) coupled to the conductors to hold them together and defining a cavity (5) having an opening at least in one surface to expose part of the conductors so that an electric element (3, 13, 22, 40) can be connected to the conductors exposed in the cavity; and a cap (6, 6a-6m) having a cap main body (7) for covering at least part of the one surface of the socket main body and attached to the socket main body. The electric element may include a resistor and a light emitting element such as an LED.

In the case where the electric element (3, 13, 22, 40) is received in the cavity of the socket main body, it is preferable that the cap attached to the socket main body presses the electric element against the conductors so that the electric element and the conductors are press-contacted to each other. For this purpose, an elastic member (41) may be provided between the cap and the electric element.

In the case where a light emitting element (3, 13, 22) is received in the cavity of the socket main body, it is preferable that the cap main body comprises an optical function part for processing and/or controlling the light emitted from the light emitting element. For instance, the cap main body may assume a desired color or the cap main body may comprise at least one of a lens (21, 23, 25), prism (20, 24), prism mirror (27), reflecting member (29), reflector (32), light conducting member (33, 35), optical modifier (34), fluorescent member, and photocatalyst. It is also possible that the optical function part has a moveable structure to vary an optical function property (e.g., direction of irradiation of light).

In a preferred embodiment of the present invention, the cap and the socket main body comprise respective engagement portions that elastically engage each other. Preferably, the engagement portion provided to one of the cap and the socket comprises a flexible member (8, 11) that extends toward the other.

It is also possible that the cap main body comprises a base (7, 33) attached to the socket main body (4), and the optical function part (45, 48) consists of a member separate from the base and is detachably attached to the base. In such a case, it is preferred that the base comprises a first light conducting member (33) disposed over the light emitting element (3) mounted in the socket main body (4), while the optical function part comprises a second light conducting member (44, 46) adapted to be detachably coupled to the first light conducting member. When the optical function part comprises more than one optical fiber (47), the first light conducting member may be hollow and provided with a lens for converging the light from the light emitting element toward the more than one optical fiber.

In one embodiment of the present invention, the cap main body comprises a light-transmissive plate portion (43) having one surface coated with photocatalyst. In such a case, the surface of the plate portion (43) coated with the photocatalyst is preferably formed with bumps and dips.

### EFFECTS OF THE INVENTION

As described above, because the socket device of the present invention comprises a cap, various functions can be easily achieved by attaching different caps. For example, in the case where an LED is mounted in the socket main body, a light-transmissive cap may be attached for protecting and holding the LED. Also, it may be possible to form a connector for establishing connection to outside apparatus by providing the cap with a pair of electroconductive terminals and externally extending cords attached to the terminals so that when the cap is attached to the socket, the electroconductive terminals of the cap contact the corresponding conductors held by the socket.

If the cap attached to the socket main body presses the electric element against the conductors so that the electric element and the conductors are press-contacted to each other, a reliable electrical contact between the electric element and conductors can be preferably achieved while preventing the electric element from being removed inadvertently out of the socket main body or rattling in the socket main body. By pressing the electric element against the conductors to achieve the electric connection therebetween, it is possible to eliminate need for welding or soldering the electric element to the conductors. This can allow the electric element to avoid being affected by thermal history that could result if the electric element is passed through a reflow furnace or the like.

The cap main body equipped with an optical function part for processing and/or controlling the light emitted from the light emitting element (3, 13, 22) allows easy processing/controlling of the light such as convergence, divergence, reflection, refraction, color change, etc. Also, selective use of caps of different optical functions can achieve various illumination effects easily. The provision of moveable structure to the optical function part enables an optical function property (e.g., direction of irradiated light) to be changed easily.

In the case where the cap and socket main body comprise respective engagement portions (8, 9, 10, 12) that elastically engage each other, inadvertent removal of the cap from the socket main body can be prevented while allowing easy attachment/detachment of the cap with respect to the socket main body.

When the cap main body comprises a base (7, 33) attached to the socket main body (4), and the optical function part (45, 48) consists of a member separate from the base and is detachably attached to the base, it is possible to easily replace the optical function part without removing the base of the cap main body. Particularly, in such a case that the base of the cap main body comprises a first light conducting member (33) disposed over the light emitting element (3) mounted in the socket main body (4), while the optical function part comprises a second light conducting member (44, 46) adapted to be detachably coupled to the first light conducting member, the base and the optical function pat can be detachably coupled to each other in a simple structure without requiring additional component parts for the coupling. When the optical function part comprises more than one optical fiber (47), it is possible to preferably increase the intensity of light output from the optical fibers by making the first light conducting member hollow and providing it with a lens for converging the light from the light emitting element toward the more than one optical fiber.

In an embodiment where the cap main body comprises a light-transmissive plate portion (43) having one surface coated with photocatalyst, it is possible to achieve photocatalytic effects, such as disinfection, by irradiating a desired light to the photocatalyst from the light emitting element received in the socket. In such a case, forming bumps and dips in the surface of the plate portion (43) coated with the photocatalyst can preferably increase the surface area of the photocatalyst to thereby improve the photocatalytic effects.

The features, objects and effects of the present invention will appear more fully from the following description of preferred embodiments of the present invention with reference to the appended drawings.

### BEST MODE FOR CARRYING OUT THE INVENTION

Now the present invention is described in the following in terms of concrete embodiments with reference to the appended drawings. It should be noted that common component parts are denoted with same reference numerals throughout the drawings.

FIG. 1 is an exploded perspective view showing an embodiment of the socket device according to the present invention, and FIG. 2 is a cross-sectional view showing an assembled state of the socket device. The illustrated socket device 1 comprises a plurality of plate-shaped conductors 2 and a chip-type LED 3 as a light source (light emitting element) electrically connected to the conductors 2 to implement a light emitting device. In this embodiment, the LED 3 has a light emitting part 3a on its top and a pair of contacts (not shown) for electric connection on its bottom. It should be noted that though the drawings show only a pair of conductors 2 and one LED 3, the number of conductors 2 and LEDs 3 can be arbitrary, and a plurality of LEDs 3 may be connected via conductors 2 patterned to form a desired circuit configuration such as series, parallel, series-parallel (parallel connection of series-connected LEDs 3) or parallel-series (series connection of parallel-connected LEDs) connections. Such plate-shaped conductors 2 can be preferably obtained by press working an electroconductive plate material.

The socket device 1 further comprises a substantially box-shaped, electrically insulating socket main body 4 coupled to the conductors 2 for positioning and/or holding the LED 3 as well as integrally holding the conductors 2. The socket main body 4 defines a cavity 5 having an opening on its top to expose part of the conductors 2 where the LED 3 is to be attached. The insulating socket main body 4 can be formed by molding resin, for example. In this embodiment, the socket main body holds together two conductors 2 which oppose to each other within the cavity 5 of the socket main body 4 and are usually applied with different voltages when in use. After received into the cavity 5, the LED 3 is connected to the conductors 2 electrically/mechanically by means of welding or soldering, for example. In this embodiment, the cavity 5 also has an opening on its bottom to enable the welding or soldering to be achieved easily.

According to the present invention, the socket device 1 further comprises a cap 6 that is engageable to the socket main body 4 so as to cover at least part of the surface (upper surface in the drawing) of the socket main body 4 formed with the opening of the cavity 5. In the illustrated embodiment, the cap 6 is made of a light-transmissive resin material, and has a rectangular plate portion 7 serving as a cap main body for covering the upper opening of the cavity 5 of the socket main body 4 and engagement pieces 8 extending from opposing sides of the plate portion 7 toward the socket main body 4 to serve as engagement portions. In this embodiment, each engagement piece 8 consists of an engagement finger having a hook-shaped end. Lower sides of the socket main body 4 are provided with grooves 9 as engagement portions, where the grooves 9 are adapted for receiving the hook shaped ends of the respective engagement fingers 8. The light-transmissive plate portion 7 of the cap 6 may be transparent or translucent.

In the above constructed socket device 1, the cap 6 is attached to the socket main body 4 by elastically engaging the engagement fingers 8 of the cap 6 to the engagement grooves 9 of the socket main body 4 after the LED 3 is received in the socket main body 4 whereby the plate portion 7 of the cap 6 presses the top of the LED 3 to prevent inadvertent drop of the LED 3 from the socket 4. This also allows the electric connection terminals provided at the bottom of the LED 3 and the conductors 2 to press-contact each other to whereby achieve reliable electric connection therebetween. It is even possible to omit welding or soldering between the LED 3 and the conductors 2. The cap 6 can be easily attached to and detached from the socket main body 4 due to the flexible engagement fingers 8, and thus it is possible to change the light color by using various caps 6 with the plate portion 7 of different colors or with the plate portion 7 including fluorescent material. For instance, it is possible to generate white light by using a blue LED as the light emitting element and yellow fluorescent material as the fluorescent material. It should be noted that though in FIG. 1(b) the engagement fingers 8 and grooves 9 are shown with a gap therebetween for the sake of clarity, they actually press-contact each other in the assembled state.

FIG. 2 is a perspective view showing a modified embodiment of the socket device of FIG. 1. In this drawing, the LED 3 is omitted and not shown. In this socket device 1a, a cap 6a comprises side walls 11 as engagement portions such that the side walls 11 extend from opposing sides of the plate portion 7 and are formed with engagement holes 10, while the corresponding sides of a socket main body 4a are formed with protrusions 12 as engagement portions for engaging with the engagement holes 10 of the side walls 11 of the cap 6a, where the height of the protrusions 12 increases gradually in the downward direction. In this embodiment also, the side walls 11 having the engagement holes 10 are flexible and thus, like the embodiment shown in FIGS. 1(a) and 1(b), the cap 6a can be easily attached to and detached from the socket main body 4a, and the elastic engagement between the side walls 11 and the protrusions 12 can urge the cap main body (or the plate portion) 7 against the top of the LED 3 received in the socket main body 4a, to thereby prevent inadvertent drop of the LED 3 and ensure reliable electric connection between the LED 3 and the conductors 2. It should be noted that in the embodiment of FIG. 2, the protrusions 12 (engagement portions) of the socket main body 4a are provided on the sides different from those through which the conductors 2 extend. Thus the engagement portions can be provided at arbitrary positions so long as the conductors 2 do not hinder the engagement between the cap 6a and the socket main body 4a.

Besides the elastic engagement between the engagement portions described above, the attachment of the cap to the socket main body may be achieved through other methods such as providing ridges (or rails) extending horizontally on opposing sides of the socket main body as engagement portions, providing horizontally extending complementary grooves on the corresponding side walls of the cap as engagement portions, and making the ridges and the grooves engage each other by sliding the cap with respect to the socket main body. However, the elastic engagement between the engagement portions is desirable in view of less tendency to suffer inadvertent disengagement as well as capability of urging the cap against the socket main body in the assembled state to whereby make the cap pressingly hold the LED received in the socket main body. Also, though the flexible members (8, 11) are provided to the cap so as to extend toward the socket main body in the above embodiments, the flexible members may be provided to the socket main body.

In the above embodiments, a chip-type LED 3 was used as a light emitting element. FIGS. 3(a) and 3(b) show an embodiment adapted for using a so-called bullet-type LED 13 having a pair of leads 13b extending from a main body 13a as a light emitting element. In FIG. 3(a), the bullet-type LED 13 is omitted. It should be also noted that component parts similar to those of FIG. 1(a) and 1(b) are denoted with the same reference numerals and detailed description thereof is omitted. In the socket device 1b of FIGS. 3(a) and 3(b), the plate portion 7 of the cap 6b has a hole 14 through which the main body 13a of the bullet-type LED 13 is allowed to pass. As clearly shown in FIG. 3(b), in the assembled state the plate portion 7 of the cap 6b presses against a collar 13c of the bullet-type LED 13 to whereby prevent inadvertent removal of the LED 13 from the socket 4. Also, the pair of leads 13b of the LED 13 are pressed against the corresponding conductors 2.

As shown in FIG. 3(c), the conductors 2 may be formed with cross-shaped holes 2a for passing the leads 13b of the bullet-type LED 13 therethrough. In this way, as shown in FIG. 3(d), parts of the conductors 2 defining the cross-shaped holes 2a flex to pressingly contact the leads 13 of the bullet-type LED 13 to establish a reliable electric/mechanical connection.

FIGS. 4(a)-4(c) are cross-sectional views similar to FIG. 1(b) and show various modified embodiments of the socket device according to the present invention. The embodiment of FIG. 4(a) has a substantially same structure as the socket device 1 of FIG. 1(b) but the conductors 2 are bent obliquely upward to elastically contact the electric connection terminals provided on the underside of the LED 3, thus achieving reliable electric connection. This can also eliminate need for welding or soldering the LED 3 to the conductors 2. The embodiment of 4(b) also has a substantially same structure as the socket device 1 of FIG. 1(b) but the LED 3 has electric connection terminals on its opposing lateral sides (not shown in the drawing), and the conductors 2 are bent upward approximately at right angle to elastically contact the electric connection terminals. In the socket device 1c of FIG. 4(c), as also shown in a perspective view of FIG. 4(d), tongue pieces 15 formed by making a cut in the plate portion 7 of the cap 6c are bent downward to press the top of the LED 3 in the assembled state, to thereby achieve reliable connection between the LED 3 and the conductors 2.

FIG. 5 is a cross-sectional view showing yet another embodiment of the socket device according to the present invention. In this socket device 1d, the cap main body of the cap 6d has a hollow cylindrical wall 16 extending upward from the plate portion 7 and a pair of electroconductive terminals 18 are provided on an inner surface of the cylindrical wall 16 to contact the conductors 2 held by the socket main body 4. The electroconductive terminals 18 inside the cap 6d are attached with cords 19 extending to outside so that an external electric apparatus can be connected to the cords 19. The socket device 1d having the cap 6d as above can implement a connector for establishing connection to an external apparatus.

FIGS. 6(a) and 6(b) are cross-sectional views showing still different embodiments of the socket device according to the present invention. In the socket device 1e of FIG. 6(a), the cap main body of the cap 6e has a prism 20 as an optical function part so that the light emitted from the LED 3 can be refracted or diverged as shown by solid lines in the drawing. In this embodiment, it is possible to change the direction of radiation of the light by rotating the cap 6e in the plan view so as to change its mounting direction with respect to the socket main body 4. In the socket device 1f of FIG. 6(b), the cap 6f comprises a lens 21 to converge or diverge the light emitted from the LED 3.

FIG. 6(c) is a perspective view showing an embodiment of the socket device using a so-called side-view LED 22 with a light emitting portion 22a on its side as a light source. In this socket device 1g, in addition to using the side-view LED 22 as a light emitting element, a resistor 40 for over-current prevention is received by the socket main body 4. Further, part of the side walls defining the cavity 5 of the socket main body 4 for exposing the conductors is removed to avoid interfering with the light emitted laterally from the side-view LED 22. The cap 6g of this socket device 1g has a side wall 23 extending normally from the plate portion 7 and the lens is provided to the side wall 23. In other words, the cap main body comprises the plate portion 7 and the side wall 23, where the side wall 23 serves as an optical function part. The side wall (lens) 23 covers the light emitting portion 22a of the side-view LED 22 in the assembled state so that the light from the side-view LED 22 passes through the lens 23. Further, in the socket device 1g, coil springs 41 are disposed between plate portion 7 and the LED 22 as well as between the plate portion 7 and the resistor 40 to urge the LED 22 and the resistor 40 toward the conductors 2 to achieve reliable electric connection. Instead of the coil springs 41, other appropriate elastic members such as a leaf spring may be used.

FIGS. 7(a)-7(i) are perspective views showing different embodiments of the cap of the socket device according to the present invention. It should be noted that as a socket main body for these caps, the socket main body 4 shown in FIGS. 1(a) and 1(b) may be used.

In the cap 6h of FIG. 7(a), a prism 24 is held in the plate portion 7 so as to be freely rotatable in a horizontal plane as indicated by the arrow. This can allow the direction of illumination of light without changing the mounting direction of the cap 6h with respect to the socket main body 4.

In the cap 6i of FIG. 7(b), a lens 25 is held by the plate portion 7 so as to be freely rotatable in the horizontal plane and tiltable in upward and downward directions as indicated by the arrows.

In the cap 6j of FIG. 7(c), a prism mirror 27 is held in the plate portion 7 so as to be rotatable in the horizontal plane as indicated by the smaller arrow. The light emitted upward from the LED 3 (see FIGS. 1(a) and 1(b)) is reflected at right angle to be irradiated in the lateral direction as indicated by the larger arrow in the drawing.

In the cap 6k of FIG. 7(d), the plate portion 7 is formed with a rectangular hole 28, and a groove 30 is provided along one side of the hole 28 for receiving an end of a substantially rectangular mirror (or reflecting member) 29. The mirror 29 is bent at a position near its end that is inserted in the corresponding groove 30 of the plate portion 7 so that the light emitted from the LED 3 abuts the mirror 29 and is reflected in a desired direction. It is possible to direct the light in varying directions by selectively using mirrors 29 of different angles. The light reflecting surface of the mirror 29 may be hairline finished. Also, the mirror 29 may be formed integrally with the plate portion 7 instead of being provided as a separate member.

In the cap 6l of FIG. 7(e), the plate portion 7 has a round hole 31 where a reflector 32 having a shape of funnel can be fitted. By inserting the bullet-type LED 13 as shown in FIG. 3(b) into the reflector 32, it is possible to reflect the light from the LED 13 by the reflector 32 so as to adjust the angle range of irradiation of the light. Preferably, the cylindrical portion of the reflector 32 inserted into the round hole 31 of the plate portion 7 has a slightly smaller inner diameter than the outer diameter of the bullet-type LED 13 and is formed with a plurality of flexible portions 32a by cutting, so that when the LED 13 is inserted, the flexible portions 32a flex outward to pressingly abut the outer surface of the LED 13.

The cap 6m of FIG. 7(f) comprises a cylindrical light conductor 33 provided on top of the plate portion 7 and an optical modifier 34 mounted thereon, so that when the light is emitted from the LED 3, the light conductor 33 and/or the light modifier 34 illuminates to produce aesthetically favorable effects.

In the embodiment of FIG. 7(g), two caps 6 to be attached to different socket main bodies 4 are connected to each other by a light conductor (light conducting column) 35 having a circular cross-section. In the case that the light conducting column 35 is made of a resin, for example, and has light diffusing property, and the LEDs 3 received in respective socket main bodies 4 have different light colors, the lights emitted from the LEDs 3 are mixed to each other in the light conducting column 35 to achieve aesthetically favorable effects. It should be mentioned that the cross-sectional shape of the light conducting column may be arbitrary and can be polygonal other than circular.

The cap 6n of FIG. 7(h) has a cylindrical light conductor (first light conductor) 33 provided on an upper surface of the plate portion 7 (i.e., a surface away from the socket 4) so that when the cap 6n is attached to the socket main body 4 (FIG. 1), the light conductor 33 is positioned over the LED 3 held in the socket main body 4. In this embodiment, the light conductor 33 is hollow and has an opening 33a at least on its top. The plate portion 7 and the hollow light conductor 33 constitute a base of the cap main body attached to the socket main body 4 by means of the engagement portions 8. Further, the cap 6n has a photocatalyst member 45 comprising a light transmissive plate portion 43 with photocatalyst coated on its top surface and a column-shaped light conductor (second light conductor) 44 provided under the plate portion 43, where the photocatalyst member 45 is a separate member from the base and serves as an optical function part. The light conductor 44 of the photocatalyst member 45 is inserted into the hollow light conductor 33 via the opening 33a so that the photocatalyst member 45 is detachably attached to the light conductor 33. With the cap 6n having the photocatalyst member 45 as above, it is possible, for example, to use an LED 3 generating ultraviolet light so that the ultraviolet light impinge upon the photocatalyst coated on the top surface of the plate portion 43 from the underside of the cap 6n, whereby effectively causing photocatalytic effects such as bacteriocidal effect. For the purpose of increasing the surface area of the photocatalyst, it is preferable to provide bumps and dips in the top surface of the plate portion 43 coated with the photocatalyst. Further, in order to conduct the light from the LED 3 (FIG. 1) to the whole part of the plate portion 43, the cross-section of the light conductor 44 may preferably increase toward the plate portion 43. The shape of the plate portion 43 may not have to be limited to rectangular but can be of any shape such as circular or hexagonal. It may even assume a three-dimensional shape such as a hemisphere. Also, the distance D between the plate portion 43 of the photocatalyst member 45 and the plate portion 7 of the base of the cap main body may be arbitrary, though it should be sufficiently large to permit smooth flow of air and achieve favorable photocatalytic effects.

Like the cap 6n of FIG. 7(h), the cap 6p of FIG. 7(i) also has a hollow light conductor 33 provided on top of the plate portion 7, and the plate portion 7 and the light conductor 33 together forms a base of the cap main body. A lens 49 is provided at the bottom of the hollow light conductor 33. Further, the cap 6p comprises a optical fiber assembly 48 having a plurality of optical fibers 47 and a light conductor 46 (second light conductor) coupled to the ends of the optical fibers 47. In other words, in this embodiment the optical fiber assembly 48 serves as an optical function part that is separate from the base of the cap main body. The light conductor 46 of the optical fiber assembly 48 is inserted into the hollow light conductor 33 via the opening 33a whereby the optical fiber assembly 48 is detachably attached to the light conductor 33. When the light from the LED 3 (FIG. 1) impinges upon the cap 6p from underside, the light converged by the lens 49 is directed in various directions via the light conductor 46 and optical fibers 47 to produce favorable aesthetic effects. The lens 49 for converging the light serves to efficiently focus the light to the optical fibers 47 to thereby increase the intensity of light emitted from the optical fibers 47. It is not always necessary to use a plurality of optical fibers 47 but it may be possible to use only one optical fiber.

Thus, by using an optical function part that is separate from the base of the cap main body, and attaching the optical function part to the base in a detachable fashion, it is possible to easily replace the optical function part with another one without detaching the base of the cap main body from the socket main body.

As described above, according to the socket device of the present invention, it is possible to achieve various processing and control of the light emitted from the light source such as an LED received in the socket main body by using a cap attachable to the socket main body and providing the cap main body with various optical functions.

FIGS. 8(a) and 8(b) show examples of application of a socket device 1f having a cap 6f with lens 21 as shown in FIG. 6(b). As shown in FIG. 8(a), the light emitted from the LED 3 can be converged via lens 21 provided to the cap 6f, directed to one end of an optical fiber 37, and irradiated from the other end. As shown in FIG. 8(b), a plurality of such light emitting devices 1f may be arranged on the ceiling and walls to achieve various illumination effects. The optical fiber 37 is flexible and can take various shapes to vary the direction of light emitted from the other end.

The present invention has been described in terms of specific embodiments, but these embodiments are for exemplary purposes only and the present invention is not limited by the illustrated embodiments. A person having ordinary skill in the art can make various alterations and modifications without departing from the technical concept of the present invention defined by the claims. For example, though in the above embodiments the cap was shown as molded as a single unit, it may consist of a plurality of parts such as two halves. The color of LED light is also arbitrary, and a yellow LED may be used for repelling insects or a blue LED may be used for attracting insects, for example.

### INDUSTRIAL APPLICABILITY

As described above, because the socket device of the present invention comprises a cap that is attached to a socket main body integrally coupled to conductors, processing/controlling of the light emitted from a light source received by the socket main body can be achieved easily by attaching a cap having an appropriate optical property to the socket. Also, the cap can function to protect the electric element such as a light source received in the socket main body, and ensure reliable connection between the electric element and conductor. Thus, the socket device of the present invention is industrially quite useful.

### BRIEF DESCRIPTION OF THE DRAWINGS

FIG. 1(a) is an exploded partial perspective view showing an embodiment of the socket device according to the present invention;

FIG. 1(b) is a cross-sectional view of the socket device of FIG. 1(a) in the assembled state;

FIG. 2 is an exploded perspective view showing another embodiment of the socket device of FIGS. 1(a) and 1(b), with the LED being omitted;

FIG. 3(a) is an exploded perspective view showing another embodiment of the socket device according to the present invention, with the LED being omitted;

FIG. 3(b) is a cross-sectional view of the socket device of FIG. 3(a) in the assembled state;

FIG. 3(c) is an exploded perspective view similar to FIG. 3(a) and shows a modified embodiment of the socket device shown in FIG. 3(a):

FIG. 3(d) is a cross-sectional view of the socket device of FIG. 3(c) in the assembled state;

FIG. 4(a) is a cross-sectional view similar to FIG. 1(b) and shows another embodiment of the socket device according to the present invention;

FIG. 4(b) is a cross-sectional view similar to FIG. 1(b) and shows another embodiment of the socket device according to the present invention;

FIG. 4(c) is a cross-sectional view similar to FIG. 1(b) and shows another embodiment of the socket device according to the present invention;

FIG. 4(d) is a perspective view of the cap shown in FIG. 4(c);

FIG. 5 is a cross-sectional view showing another embodiment of the socket device according to the present invention;

FIG. 6(a) is a cross-sectional view similar to FIG. 1(b) and shows another embodiment of the socket device according to the present invention;

FIG. 6(b) is a cross-sectional view similar to FIG. 1(b) and shows another embodiment of the socket device according to the present invention;

FIG. 6(c) is an exploded perspective view showing another embodiment of the socket device according to the present invention;

FIG. 7(a) is a perspective view showing another embodiment of the cap of the socket device according to the present invention;

FIG. 7(b) is a perspective view showing another embodiment of the cap of the socket device according to the present invention;

FIG. 7(c) is a perspective view showing another embodiment of the cap of the socket device according to the present invention;

FIG. 7(d) is a perspective view showing another embodiment of the cap of the socket device according to the present invention;

FIG. 7(e) is a perspective view showing another embodiment of the cap of the socket device according to the present invention;

FIG. 7(f) is a perspective view showing another embodiment of the cap of the socket device according to the present invention;

FIG. 7(g) is a perspective view showing another embodiment of the cap of the socket device according to the present invention;

FIG. 7(h) is a perspective view showing another embodiment of the cap of the socket device according to the present invention;

FIG. 7(i) is a perspective view showing another embodiment of the cap of the socket device according to the present invention;

FIG. 8(a) is a cross-sectional view showing a light emitting apparatus using the socket device shown in FIG. 6(b); and

FIG. 8(b) is a schematic view showing an example of arrangement of the light emitting apparatus shown in FIG. 8(a).

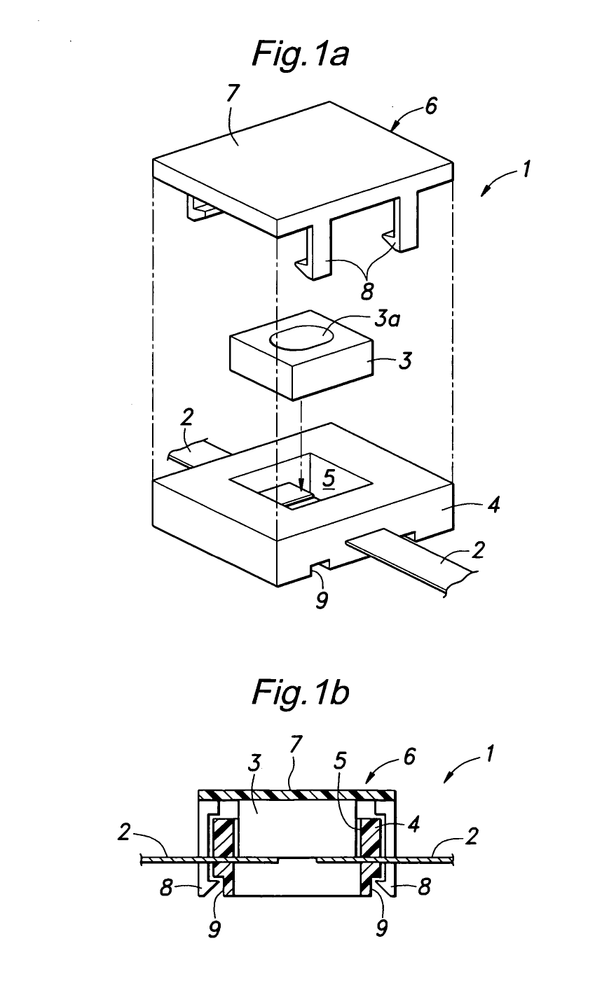

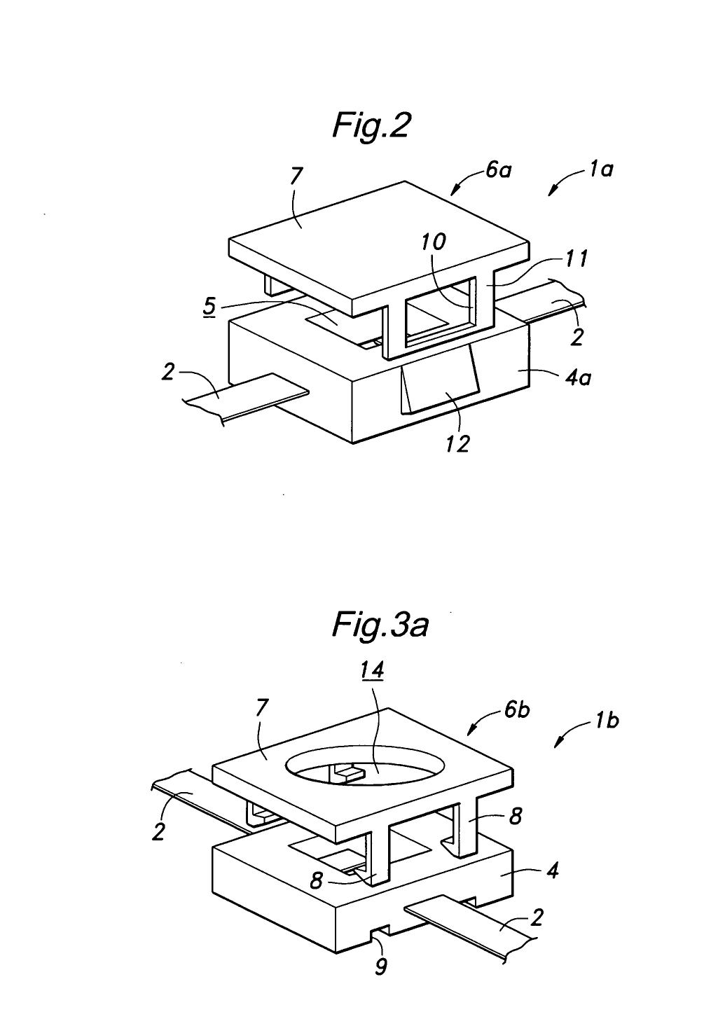

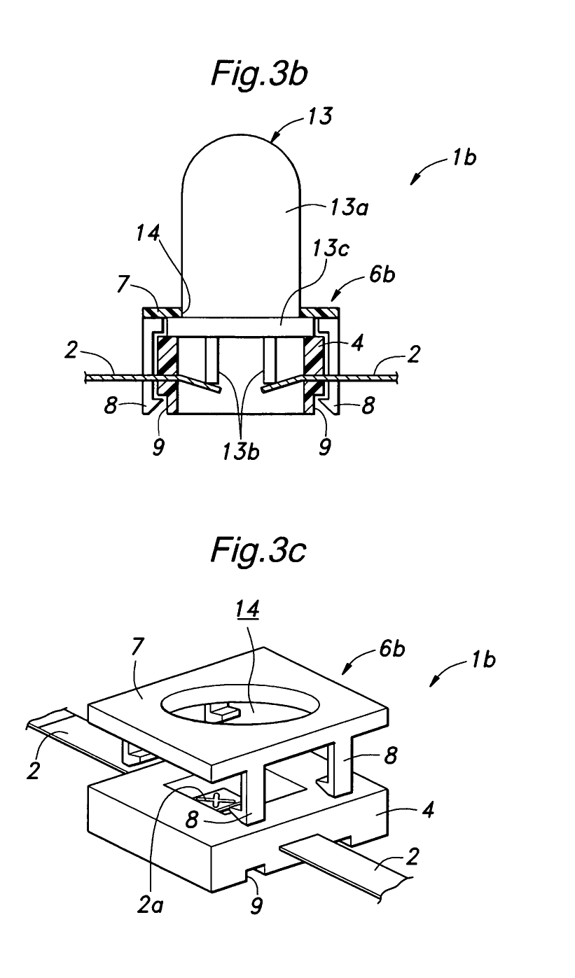

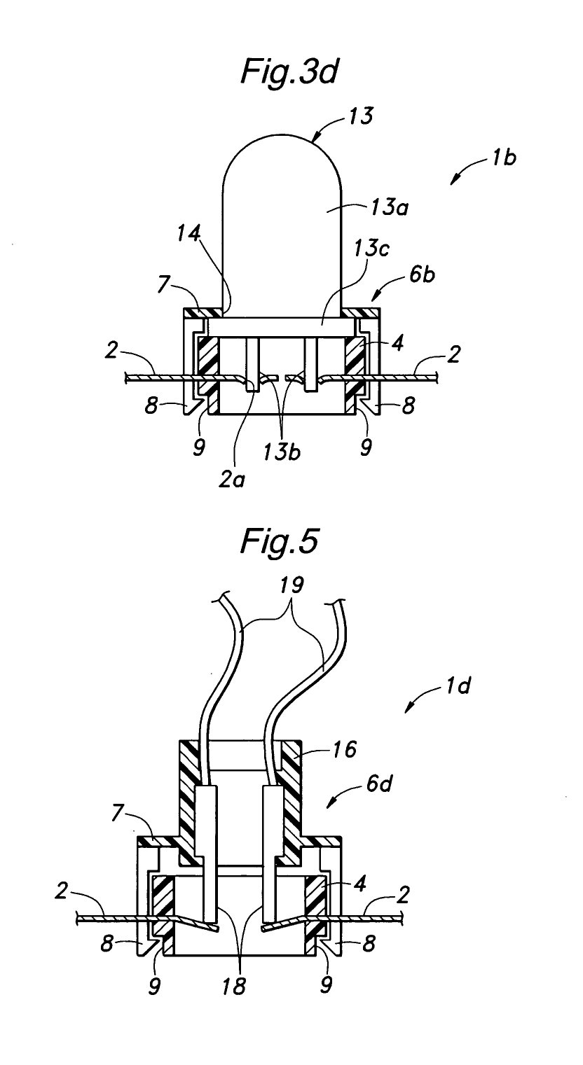

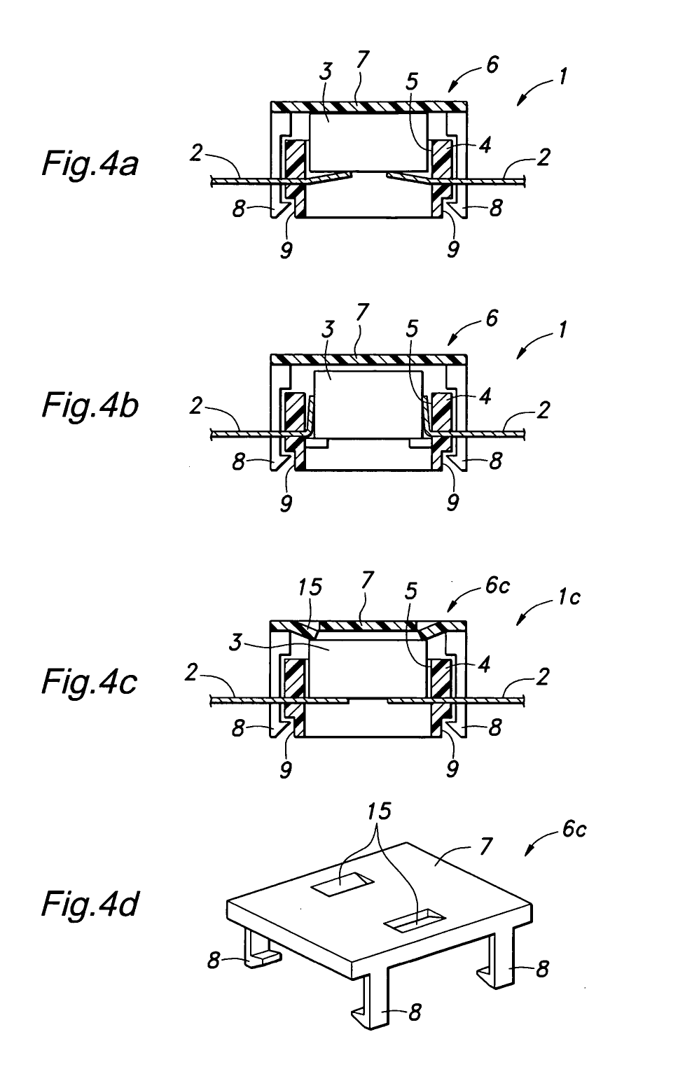

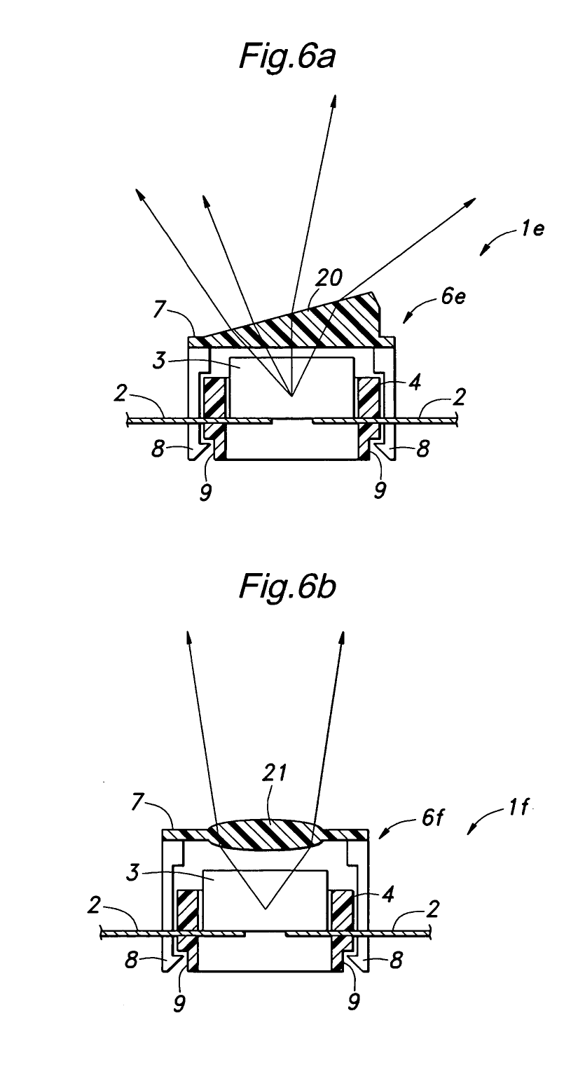

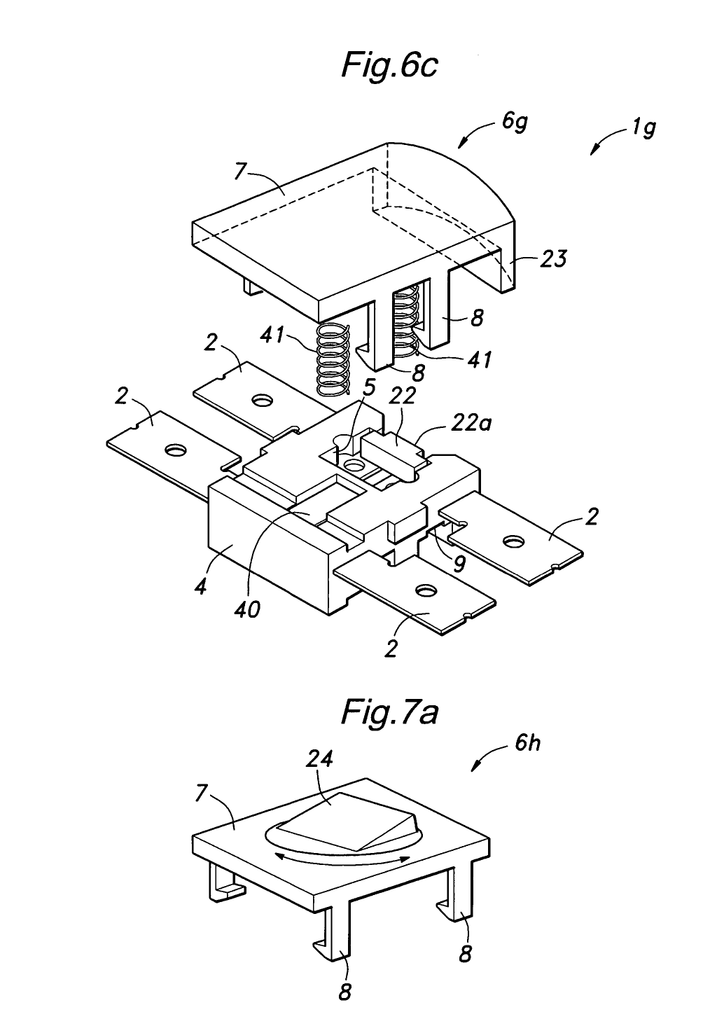

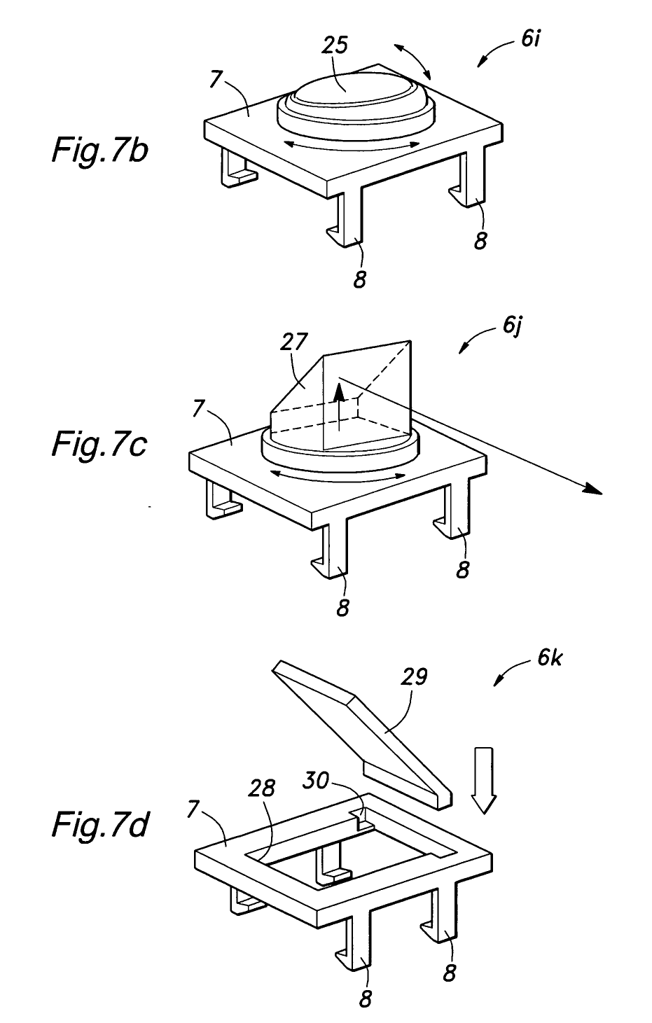

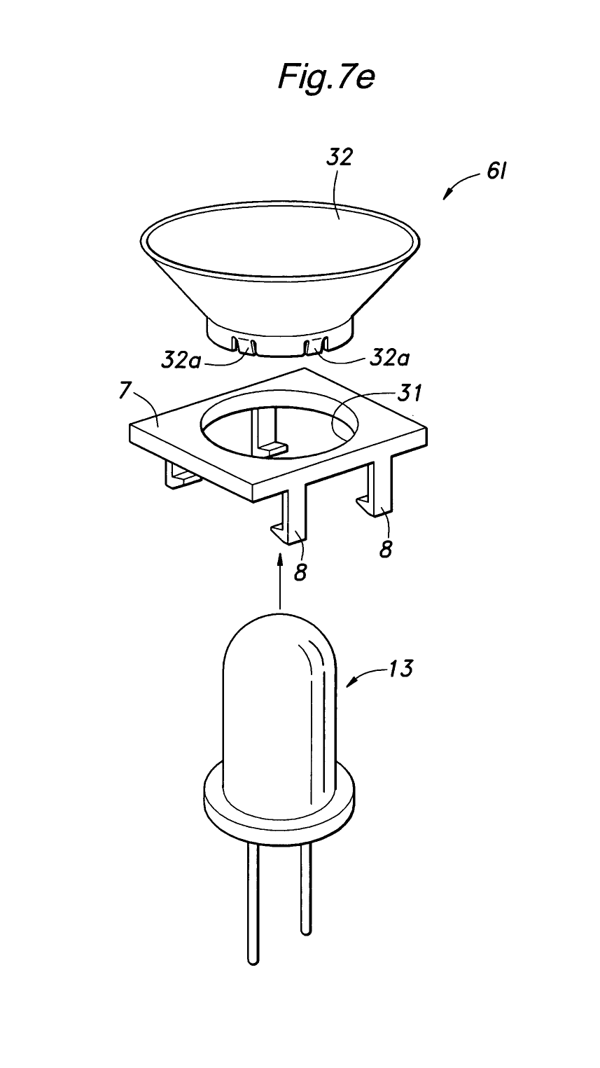

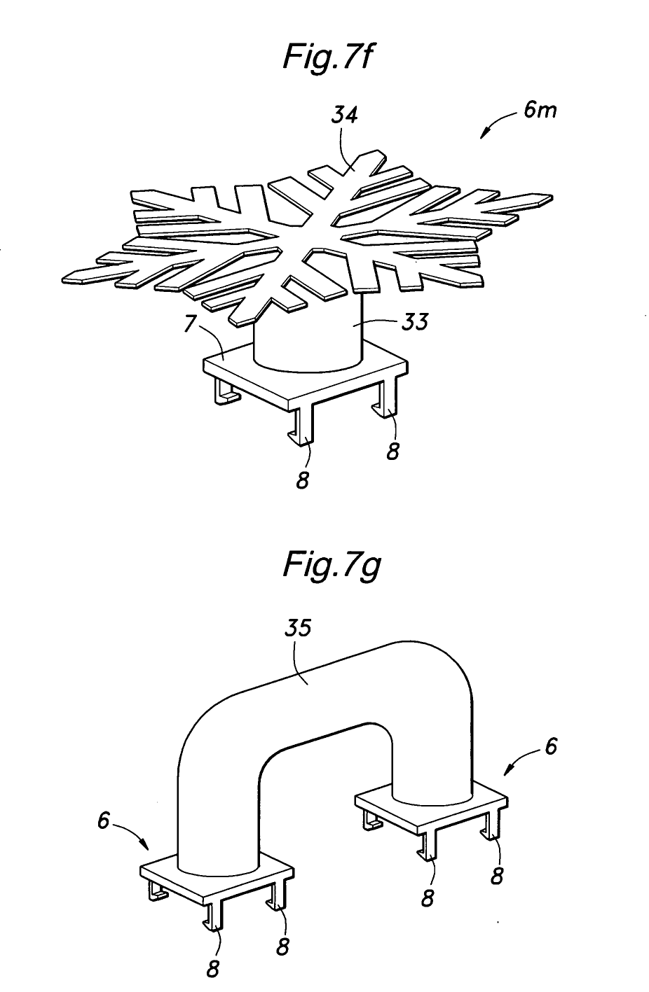

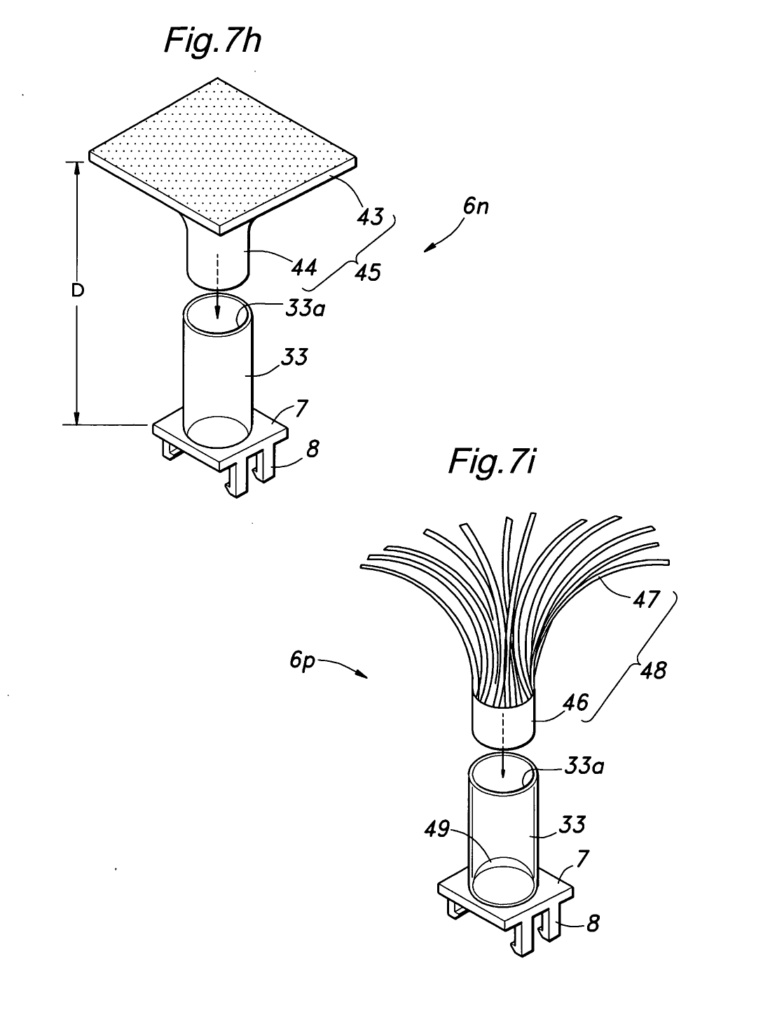

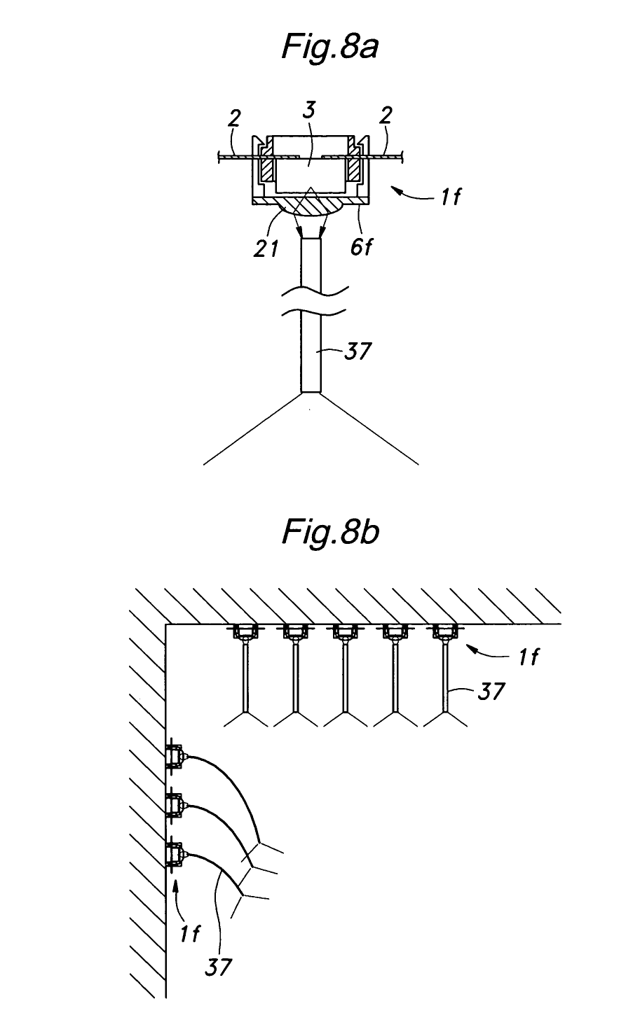

### GLOSSARY

| 1, 1a-1g | socket device | | |
|---|---|---|---|
| 2 | conductor | 2a | hole |
| 3 | LED | 3a | light emitting portion |
| 4, 4a | socket main body | 5 | cavity |
| 7 | plate portion | 8 | engagement finger |
| 9 | groove | 10 | engagement hole |
| 11 | side wall | 12 | protrusion |
| 13 | bullet-type LED | 13a | main body |
| 13b | lead | 13c | collar |
| 14 | hole | 15 | tongue piece |
| 16 | cylindrical wall | 18 | electroconductive terminal |
| 19 | cord | 20 | prism |
| 21 | lens | 22 | side-view LED |
| 22a | light emitting portion | 23 | side wall (lens) |
| 24 | prism | 25 | lens |
| 27 | prism mirror | 28 | hole |
| 29 | reflector (mirror) | 30 | groove |
| 31 | hole | 32 | reflector |
| 32a | flexible portions | 33 | light conductor |
| 33a | opening | 34 | optical modifier |
| 35 | light conducting column | 37 | optical fiber |
| 40 | resistor | 41 | coil spring |
| 43 | plate portion | 44 | light conducting member |
| 45 | photocatalyst member | 46 | light conducting member |
| 47 | optical fiber | 48 | optical fiber assembly |
| 49 | lens | | |

1. A socket device, comprising:
a plurality of conductors;
a socket main body coupled to the plurality of conductors to hold the conductors together and defining a cavity having an opening at least in one surface to expose part of the conductors so that an electric element can be connected to the conductors exposed in the cavity; and
a cap having a cap main body for covering at least part of the one surface of the socket main body and attached to the socket main body.

2. The socket device according to claim 1, wherein the electric element is received in the cavity of the socket main body, and the cap attached to the socket main body presses the electric element against the conductors so that the electric element and the conductors are press-contacted to each other.

3. The socket device according to claim 1, wherein a light emitting element is received in the cavity of the socket main body, and the cap main body comprises an optical function part for processing and/or controlling the light emitted from the light emitting element.

4. The socket device according to claim 3, wherein the cap main body is light-transmissive and assumes a desired color.

5. The socket device according to claim 3, wherein the cap comprises at least one of a lens, prism, prism mirror, reflector, light conducting member, optical modifier, fluorescent member, and photocatalyst.

6. The socket device according to claim 3, wherein the optical function part has a moveable structure for varying an optical function property.

7. The socket device according to claim 1, wherein the cap and the socket main body comprise respective engagement portions that elastically engage each other.

8. The socket device according to claim 3, wherein the cap main body comprises a base attached to the socket main body, and the optical function part consists of a member separate from the base and is detachably attached to the base.

9. The socket device according to claim 8, wherein the base comprises a first light conducting member disposed over the light emitting element mounted in the socket main body, while the optical function part comprises a second light conducting member adapted to be detachably coupled to the first light conducting member.

10. The socket device according to claim 9, wherein the optical function part comprises more than one optical fiber, and the first light conducting member is hollow and provided with a lens for converging the light from the light emitting element toward the more than one optical fiber.

11. The socket device according to claim 3, wherein the cap main body comprises a light-transmissive plate portion having one surface coated with photocatalyst.

12. The socket device according to claim 11, wherein the surface of the plate portion coated with the photocatalyst is formed with bumps and dips.
